(19) United States
(12) Patent Application Publication
(10) Pub. No.: US 2008/0210338 A1
(43) Pub. Date: Sep. 4, 2008

(54) Router guide for different width doors and hinges

(76) Inventor: Felix C. Ponce, Reseda, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/074,572

(22) Filed: Mar. 6, 2008

Related U.S. Application Data
(63) Continuation-in-part of application No. 11/640,756, filed on Dec. 19, 2006.

(51) Int. Cl. B27C 5/00

(52) U.S. Cl. 144/144.51; 409/178

(57) ABSTRACT

Improvements in an adaptable router template guide are disclosed. The router guide is adjustable for door or door jam widths of 1⅜, 1¾ and 2¼ with simple spring loaded stops and detents. Interchangeable and adjustable routing templates are also provided to accommodate different size and shapes of striker plates, hinge plates and door jambs. The router template further includes debris ports for removal of sawdust. In operation the router guide is set for the width of the door and secured to the door or door frame. The correct plate is installed on into the guide and the pocket is routed. The combinations of door width and template plates allows the guide to be used with numerous styles of door hardware that are both currently manufactured and may be available in the future.

### CROSS REFERENCE TO RELATED APPLICATION

This application is a continuation-in-part of applicant's co-pending application Ser. No. 11/640,756 filed Dec. 19, 2006 the entire contents of which is hereby expressly incorporated by reference herein.

### DESCRIPTION

1. Field of the Invention

The present invention relates to a universal router guide for use with doors and door jams of different widths, hinge lengths and hinge corners. In particular the router guide is adjustable for doors of 1⅜, 1¾ and 2¼ inch widths and includes a number of changeable router guide plates to match the dimensions of the plate to be recessed. The router template further includes debris ports for removal of sawdust.

2. Background of the Invention

When doors are installed into door frames the hardware such as hinges, striker plates and lock set typically have a plate that is reset into the door or door frame. The shape of the pockets is often variable based upon the manufacturer and the type of lock or hinge. Various types of fixtures and jigs have been designed for use with a router to cut these pockets or recesses. Some of these various fixtures have included clamping devices for holding pieces of wood. Several of the fixtures have included some form of a template for a router to follow in order to provide a surface design or to form certain cuts for an appropriate joint.

U.S. Pat. No. 3,841,368, issued on Oct. 15, 1974 to Nicholas H. Ritter discloses a routing device which has parallel guides on a guide base to position a work piece. A tool platform to position and support the tool, a tool support plate and a frame to provide angular movement of the tool, and selective indexing mechanisms which are disposed between the parallel guides and the frame, the frame and the blade, and the tool platform and the tool support plate. While this device discloses a router template the template does not allow for attachment to door or door frames of different thicknesses, or does it disclose a changeable router template or ports for debris discharge.

U.S. Pat. No. 4,356,849, issued Nov. 2, 1982 to Donald L. Fredrickson discloses a Molding Curvature Template Fixture, which holds a strip of molding and provides a template for a portable router to follow the shape of the molding to make molding with a similar cross-sectional shape of the shaped side of the molding. The fixture includes a box-section frame which has a series of lateral slots and a clamping mechanism. An insert may be attached to the box section frame to provide a guiding surface for cutting molding which has a non-standard shape. While this device discloses a router template the template does not allow for attachment to door or door frames of different thicknesses, or does it disclose a changeable router template or ports for debris discharge.

U.S. Pat. No. 4,323,100 issued Apr. 6, 1982 to Howard Silken discloses a Router Guide that includes an attachment to the base of a router with a central opening for passing the router bit. On the bottom, the guide plate has a series of openings spaced apart along a spiral of progressively increasing radius which has the central opening as its center. A pivot pin is selectively insertable into any one of these openings. The pivot pin has a pointed end for insertion in a work piece at the center of a circular groove which is to be cut in the work piece by the router bit as the guide plate is rotated about the pivot pin. While this device discloses a router template the template does not allow for attachment to door or door frames of different thicknesses, or does it disclose a changeable router template or ports for debris discharge.

U.S. Pat. No. 4,319,615, issued Mar. 16, 1982 to Henry A. Ditmanson discloses a Router Attachment for Ornamenting a Work piece that includes a set of adjustable rails on a track which can be oriented in any given direction by placing the track on a turntable. A wheeled carriage rides to or fro on the track and carries a router. The router bit rises and falls in response to the particular profile of the rails and cuts recesses in an underlying work piece which has shapes dependent on rail contour, bit size and shape and extent of carriage travel. While this device discloses a router template the template does not allow for attachment to door or door frames of different thicknesses, or does it disclose a changeable router template or ports for debris discharge.

U.S. Pat. No. 4,299,263, issued Nov. 10, 1981 to Charles D. Skinner discloses a Mechanical Router Guide. The router guide allows the router to move above the surface of a stationary piece, whereby the router is subject to a composite, and three directional movement as it is moved above the work piece. The indexing table carries a template holding frame which can be slanted at an adjustable angle in relation to the work piece in order to create designs of varying depth and width into the work piece. While this device discloses a router template the template does not allow for attachment to door or door frames of different thicknesses, or does it disclose a changeable router template or ports in the template for debris discharge.

### BRIEF SUMMARY OF THE INVENTION

It is an object of the universal router guide to provide a woodworking fixture which holds a portion of a door or door jam and provides a template for use with a portable router for cutting an opening for a latch face on the door or door frame. The router guide is essentially a rectangular configuration with a flat top and bottom. The guide is secured to a door or door frame with kept nails what are driven into the door or door frame to maintain the position of the guide. The elongated sides of the guide are configured to mate with the door or door frame to a fit that minimizes the movement of the guide on the frame of door.

It is another object of the universal router guide to provide a door width adjustment mechanism that adapts the router guide to three different width doors. The adjustment is accomplished using solid stops consisting of a slot with screws and spring loaded pin(s) that prevent travel beyond the screws or pins. The pins are depressed to allow the stop plate to move beyond the spring loaded pin(s). Identification is placed on the guide to indicate the width of the door that is being routed. Stops are provided on both ends of the universal router guide to maintain a parallel relationship of the guide to the door or door frame.

It is another object of the universal router guide to provide a guide with changeable routing templates. The templates are secured into the guide and match the area that needs to be routed from the door or door frame. The universal nature of the guide allows a nearly endless variety of different plates to be attached for currently available shapes as well as shapes that will be available in the future. The plates are typically secured within the guide using threaded hardware that provides a flush top surface that does not interfere with the base of a portable router.

It is still another object of the universal router guide is to provide a router guide with side ports that allow removed material to be discharged out the side of the guide. In many installations the debris remains inside the guide until the routing operation is complete. The debris discharge holes keep the area within the guide clear allowing better visibility of the area being routed.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a top isometric view of a universal latch template.

FIG. 2 shows a top isometric view of a universal strike template with a number of different routing templates.

FIG. 3 shows a detailed top isometric view of the three position door thickness stop gauge.

FIG. 4 is a bottom isometric view of the template showing the debris vents.

FIG. 5 shows an isometric view of a template with reversible plates for a single routing location.

FIG. 6 shows a top view of the reversible template.

FIG. 7 shows an isometric view of a router template for three hinge locations.

FIG. 8 shows an isometric view of a router template for four hinge locations.

FIG. 9 shows an isometric end view of the router template showing details of the door stop and the door width adjustment handle.

FIG. 10 shows a side view of the router template on a doorjamb.

FIG. 11 shows a side view of the router template on a door where the width of the door is being set.

FIG. 12 shows a bottom view of the door width adjustment mechanism.

### DETAILED DESCRIPTION

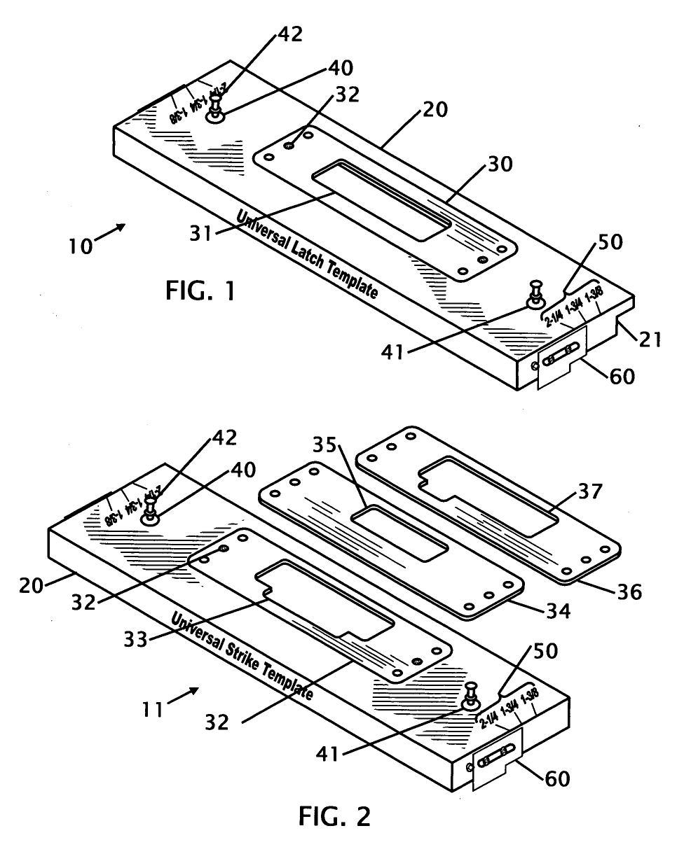

Referring first to FIG. 1 that shows a top isometric view of a universal latch template 10. The template is essentially a flat rectangular shape 20. In the preferred embodiment the template is fabricated from wood, but it is also contemplated that the template can be made from metal, plastic or other similar material that has sufficient structural rigidity to provide the functions herein disclosed. The template has two elongated sides with a central cut-out area with a depression where a router guide 30 in installed. When the template is configured as a latch template, an elongated recess 21 exists on one side of the template to locate the template in a doorway door jamb.

The router guide 30 is removable from the template and can be changed to accommodate different size and shaped pockets that need to be routed. In this figure the router guide 30 is shaped for a rectangular opening 31. Other router guides are shown and described in more detain with FIG. 2 herein. The router guide is secured to the template with threaded fasteners 32 such as screws, but other types of securing methods are contemplated. Screws are preferred because they allow the fasteners to sit flush below the top surface of the router guide 30. The template is temporally retained on the door or door frame with a removable nail 42. These removable nails are retained in a base 40 and 41 that both guide the nail and allow the nail(s) to be easily removed after the routing operation is complete.

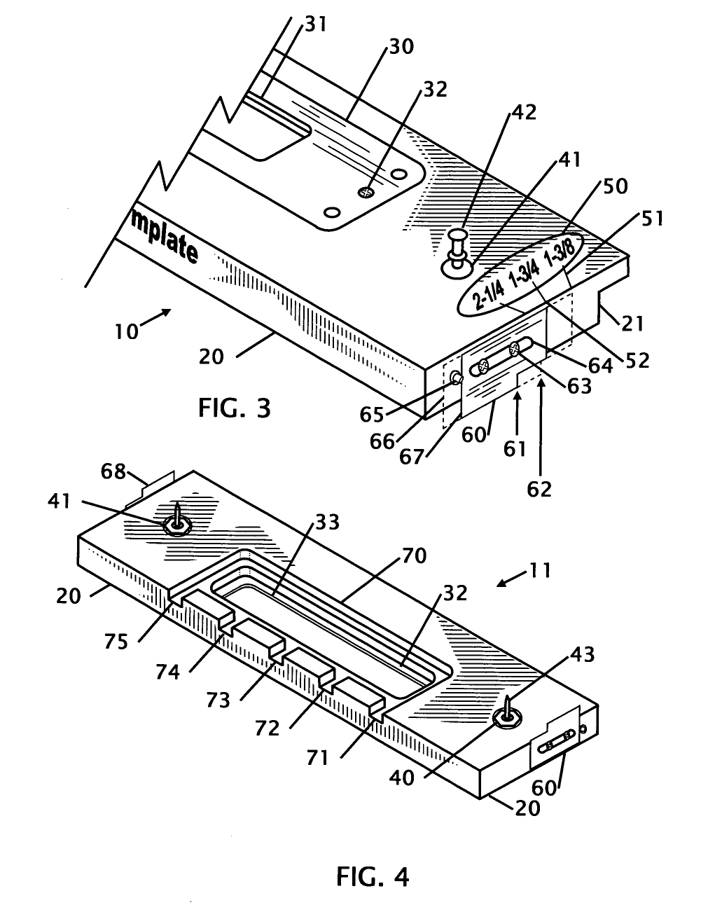

In operation the template is brought into position on the door or door frame and the removable nails are driven into the door or door frame. The recessed pocked in the door or door frame is routed and the template is removed. Both sides of the template have indicator plates 60 to adjust the template for the width of the door or doorjamb width. In the preferred embodiment the adjustment 60 is for three widths of 1⅜, 1¾ and 2¼ inch as identified with item 50. The features of the indicator plate is shown and described in more detail in FIG. 3. In a brief description of this feature it utilizes a slot with travel stops and a spring loaded pin to positively indicate the location where the stop indicator plate 60 should be placed.

FIG. 2 shows a top isometric view of a universal strike template 11 with a number of different routing templates. This template is for routing the striker plate as opposed to the latch plate as shown and described in FIG. 1. The major difference between these two templates is the notch 20 that is present in the template shown in FIG. 1 but is not present in the template shown in FIG. 2. A third template for hinges is not shown, but the construction and the features are similar to the templates shown and described herein.

The template shown in FIG. 2 is essentially a flat rectangular shape 20. The template has two elongated sides with a central cut-out area with a depression where a router guide 32 in installed. The router guide is retained in the template with screws or similar hardware that allows the router guides to be removed or removable. In this figure one router guide 32 is installed in the template with an opening in the guide 33 that corresponds to the area that will be routed from a door. A second router guide 34 is shown with its corresponding area 35 that will be routed and a third router guide 36 is shown with its corresponding area 37 that is routed. While only three router guides are shown many different router guides are contemplated that correspond to the striker plates that are available from lock , hinge or similar hardware manufacturers. Because the template can universally accept different router guides the template is usable with lock set that have not yet been design, or used in construction. The template is temporally retained on the door with a removable nail 42. These removable nails are retained in a base 40 and 41 that both guide the nail and allow the nail(s) to be easily removed after the routing operation is complete.

Both sides of the template have indicator plates 60 to adjust the template for the width of the door. In the preferred embodiment the adjustment 60 is for three widths of 1⅜, 1¾ and 2¼ inch as identified with item 50. The features of the indicator plate is shown and described in more detail in FIG. 3.

FIG. 3 shows a detailed top isometric view of the three position door thickness stop gauge. The template shown in this figure is for the universal latch template 10. Only one end of the elongated template 20 is shown to provide detail on the indicator plate 60 and its function. The template 20 is shown with the elongated recess 21, a router guide 30 secured in the template with recessed screw 32, and the opening for the router guide 31. The template is temporally retained on the door frame with the removable nail 42 in the base 41 to allow the nail(s) to be easily removed after the routing operation is complete. Marking locations 50 identify where the indicator plate is to be positioned for door frames or doors of various widths. The numerical values corresponding to the door widths and a leader line 51 shows the preferred position for the indicator plate. The plate 60 is shown in a position indicating 1¾ inch thick door shown with mark 52. The position of the plate is positively identified when the edge 67 of the plate is against the stop 65. It should be noted that the plate 60 is shown located such that the screws 63 in the slot 64 exist in the middle travel position.

To obtain the 1⅜ inch thick door position the screws 63 are loosened and the plate 60 is slid all the way to the right so the body of the screw prevents further travel of the plate. This places the template in a position shown with dashed line 62. To obtain the position 51 of the plate for the 1¾ inch thick door the screws 63 are loosened and the plate is slid to the left until it contacts pin 65. To obtain the 2¼ inch thick door position the pin 65 is depressed and the plate 60 is slid over the top of the depressed pin until the edge of the plate 60 stops against the right screw 63. This places the template in a position shown with dashed line 66. In operation the edge 61 is used to position the template on the side of the door frame. While the spring loaded pin allows for three different positive stop positions it is contemplated that more than one spring loaded pin can be used to provide more than three discrete stop positions.

FIG. 4 is a bottom isometric view of the template 11 showing the debris vents. This underside view shows the bottom edges of the indicator plates 60 and 68 located on the ends of the elongated template 20. The ends of the plates are shown rising above the surface of the template. The removable nails 40 and 41 are shown with the nail 43 sticking out beyond the end of the removable nail holders 40 and 41. A portion of the bottom of the router guide 32 is seen with the opening 33 in the router guide. There is a recess 70 in the bottom of the template that provides clearance for the debris that is routed away. Vents 71-75 extend to the sides of the template to allow debris to be expelled out the sides of the template. In the figure shown five vents are shown, but as few as one or more than five vents can be used. The use of multiple vents allows for the area between the vents to sit solidly against the door or door frame that makes the template more stable when routing a pocket.

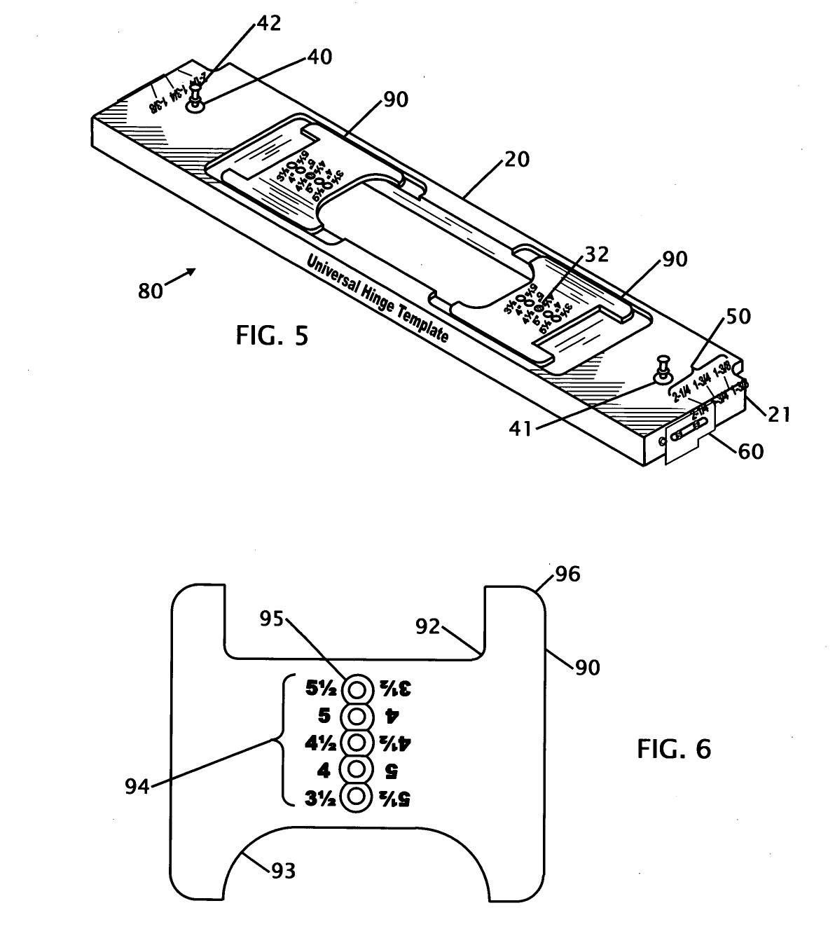

FIG. 5 shows an isometric view of a template with reversible plates for a single routing location. FIG. 6 shows a top view of the reversible router template 90 that is shown in FIGS. 5, 7 and 8. In FIG. 5 the template 80 uses two identical and reversible routing templates 90. Each template 90 (FIG. 6) has one side configured for ¼ radius cornered routing 92 and an opposing side configured for ⅝ radius rounded corner routing 93. In FIG. 5 the template 20 is shown with the elongated recess 21, and two reversible router guides 90 secured in the template with recessed screw 32. The router guides 90 are temporally retained on the template 20 that is in turn securable to a door frame with the removable nails or pins 423 that are retained in the nail guides or holders 40 and 41. The nails or pins 42 are driven into a door frame and easily removed after the routing operation is complete. Marking locations 50 identify where the indicator plate is to be positioned for door frames or doors of various widths as previously shown and described. The plate 60 is shown in a position indicating 1¾ inch thick door shown with marks 50. Each routing template 90 is secured to the wooden base 20 with a screw 32. The routing template 90 has a series of drilled and countersunk holes 95. Each hole corresponds to a different hinge length from 3½ inches to 5½ inches 94. The outside corners of the reversible router template 90 are rounded 96 to fit more easily into the recess(s) of the Universal Hinge Template 80. In the preferred embodiment the radius on the small radiused corner 92 is ¼ inch in radius, while the rounded corner 93 is slightly larger than ⅝ inch in radius to accommodate the ⅝ radius of a hinge.

In operation the door installer determines the hinge size and the hinge radius, flips or rotated the reversible router guide templates 90, adjusts the reversible router template guides 90 to correspond to the hinge length 3½ to 5½.

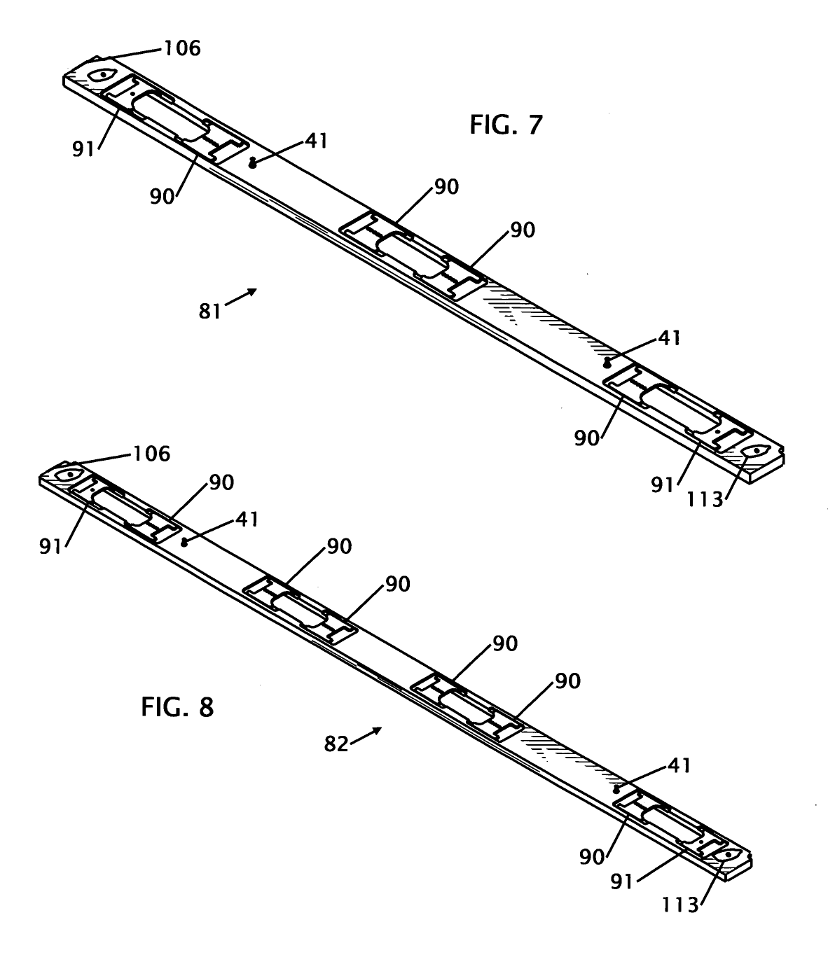

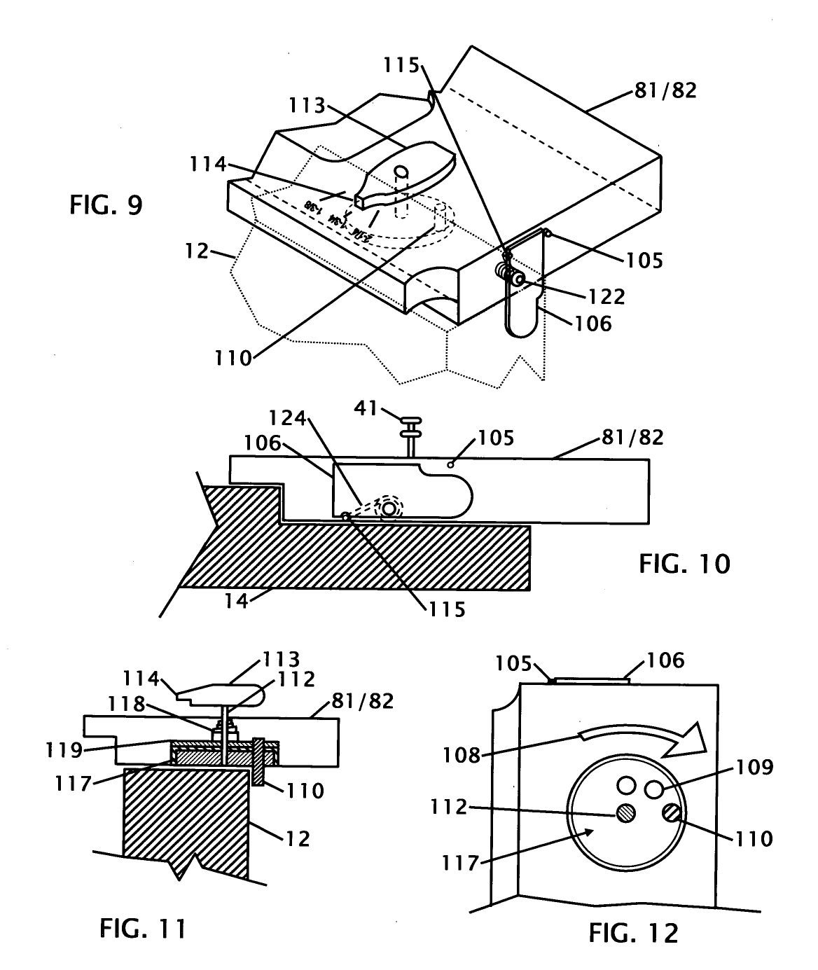

FIG. 7 shows an isometric view of a router template for three hinge locations 81. FIG. 8 shows an isometric view of a router template for four hinge locations 82. The center routing locations are basically the same as the reversible router template guide(s) 90 shown and described in FIG. 5. The outer reversible router hinge templates 91 are not adjustable for length, but are reversible to accommodate square or rounded corner hinges. The corresponding hinge plate 90 (to plate 91) is adjustable to accommodate the hinge size. In operation the ends of the door hinge routing guides are adjusted to the door width as shown and described in the previous figures. The reversible routing guide templates 90, 91 are rotated or reversed to accommodate the type of hinge corners (square or rounded), and then the location of the reversible routing guide templates 90 are adjusted to accommodate the length of the hinges. Knob handle 113 allows an installer to adjust the template for use on doors of different widths. The knob and adjustment is shown and described in more detail in FIGS. 9, 11 and 12. A small portion of the door stop 106 is visible on the ends of each template shown. The door stop 106 is shown and described in more detail with FIGS. 9 and 10. The hinge template 81 or 82 is temporarily nailed 41 to the door and the hinge pockets are routed. The hinge template 81 or 82 is then removed for use on another door.

FIGS. 9-12 show the door stop 106 and the door width adjustment mechanism. FIG. 9 shows an isometric end view of the router template showing details of the door stop 106 and the door width adjustment handle 113. The template 81 or 82 is shown mounted on a door 12. A door stop 106 provides a positive stop for locating the template 81 or 82 on the end of the door 12. The door stop 106 is rotationally secured by a threaded fastener 122. The threaded fastener 122 allows the door stop 106 to be rotated down as shown in FIG. 9, where a stop pin 105 prevents further rotation, to a horizontal position, as shown in FIG. 10. The purpose of rotating the door stop 106 is to allow the template 81 or 82 to be used on a door, as shown in FIG. 9 where it is being used, and on a doorjamb 14, as being shown in FIG. 10. A spring 124, in FIG. 10, maintains the door stop 106 is an extended orientation. A slot 115 in the door stop 106 maintains the position of the spring on the door stop plate 106.

The door width adjustment handle 113 has an indicating pointer 114 to indicate the width the door is being set to route. In the preferred embodiment the door widths are 1⅜, 1¾ and 2¼, but the template can be configured for wider or narrower door widths. In FIG. 10 the retained removable nail 41 is shown. From FIG. 9 the locating stop pin 110 for the door is shown under the door width adjustment handle 113. The locating stop pin for the door 110 is shown in more detail with FIG. 11.

FIG. 11 shows a side view of the router template 81 or 82 on a door 12 where the width of the door is being set. The locating stop pin 110 can be placed in one of three contemplated locations. In FIG. 12 a bottom view of the template is shown where the locating stop pin 110 is placed in the outer most location. Two other locating stop pin locations 109 are shown on the turning wheel 117. It should be noted that each location for the locating stop pin 110 is placed at a different distance from the central rotating rod 112 that is secured to the handle 113. As the handle 113 is rotated 108 each stop pin location 109 can be selected and the locating stop pin 110 is set into the desired stop pin location 109. In FIG. 12 the door stop 106 and the stop pin 105 is visible on the end of the router template 81 and 82. Referring back to FIG. 11 the locating pointer 114 is shown on the end of the door width adjustment handle 113. The door width adjustment handle 113 is connected to the turning wheel 117 with a rotating rod 112. A spring 118 lifts the locating stop pin 110 to allow the pin remain raised with not needed, but easily lowered by pressing down on the door width adjustment handle 113. The turning wheel 117 is capped with a metal bed 119 attached to the wooden template. The metal bed 119 provides structural rigidity to the locating stop pin 110 to maintain the pin in a perpendicular relationship with the bottom of the template 81 or 82.

Thus, specific embodiments of universal router template have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An adaptable router template guide comprising:
an elongated rectangular router base adapted for securing a router base onto a door or door frame wherein said router base has physical stops to allow said router base to locate on at least three different width doors or door frames to ensure routing a pocket in a desired location;
at least two guide plates mounted to said elongated rectangular router base where in each of said at least two guide plates have opposing forked sides wherein;
a first side is configured for routing square or small radiused corner hinges and,
a second side configured for routing large radiused corner hinges.

2. The adaptable router template guide from claim 1 wherein at least one of said physical stops includes a spring loaded pin that is temporally depressed to bypass said spring loaded physical stop to allow said guide to utilize another physical stop that exists on an opposite side of said spring loaded pin.

3. The adaptable router template guide from claim 1 that further includes locating plates located on narrow ends of said base that are positionable on said physical stops to set a width of a door or door frame.

4. The adaptable router template guide from claim 1 that further includes a rotational end stop that provides a positive locator for an end of a door and said rotational end stop can be rotated when said adaptable router template is routing a doorjamb.

5. The adaptable router template guide from claim 1 that further includes markings to correlate said physical stops with a door or door jam width.

6. The adaptable router template guide from claim 1 that further includes at least one vent located on said bottom of said guide to allow for removed debris to be expelled from within said guide.

7. The adaptable router template guide from claim 1 that further includes changeable router templates that can be removed and replaced for routing different size and shape recesses.

8. The adaptable router template guide from claim 1 wherein each at least two guide templates has a plurality of holes for locating said at least two guide templates is discrete locations on said elongated rectangular router base.

9. The adaptable router template guide from claim 8 wherein said discrete location correspond to hinges of 3½, 4, 4½, 5 and 5½ inches.

10. The adaptable router template guide from claim 1 wherein said first side routes small radiused corners of ¼ inch and said second side routes a radiused corner of ⅝ inch.

11. The adaptable router template guide from claim 1 that further includes at least one vent located in a side of said base to allow for removed debris to be expelled from within said guide.

12. The adaptable router template guide from claim 11 wherein said bottom of said base has an island portion to provide structural support under said router base with a plurality of vents to maximize debris expelling.

13. The adaptable router template guide from claim 11 wherein said vents exist on both sides of said template.

14. The adaptable router template guide from claim 1 that further includes an adjustable door width stop mechanism that uses a locatable pin on a circular turning wheel where said locatable pin is moved closer or further to a central axis of said circular turning wheel to set a door width for routing.

15. The adaptable router template guide from claim 1 that has three pairs of at least two guide plates along said elongated rectangular router base to route recesses for two or three hinge plates.

16. The adaptable router template guide from claim 1 that has four pairs of at least two guide plates along said elongated rectangular router base to route recesses for two, three or four hinge plates.

17. The adaptable router template guide from claim 1 wherein said at least two guide plates exist in a recessed track within said elongated rectangular router base to maintain parallel alignment of said at least two guide plates.

18. The adaptable router template guide from claim 1 wherein said at least two guide plates are identical.

19. The adaptable router template guide from claim 15 wherein said outer most guide plates are reversible and exist in a fixed location while their corresponding guide plate is adjustable for a size of a routed recess.

20. The adaptable router template guide from claim 16 wherein said outer most guide plates are reversible and exist in a fixed location while their corresponding guide plate is adjustable for a size of a routed recess.
